(19) United States
(12) Patent Application Publication
(10) Pub. No.: US 2004/0193471 A1
(43) Pub. Date: Sep. 30, 2004

(54) Logistics control information system and method

(75) Inventors: Mamoru Ozaki, Tokyo (JP); Kazuhiko Taniguchi, Tokyo (JP); Shinobu Itoh, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/802,132

(22) Filed: Mar. 15, 2004

(30) Foreign Application Priority Data
Mar. 31, 2003 (JP) 2003-093136

(51) Int. Cl. G06F 17/60

(52) U.S. Cl. 705/8

(57) ABSTRACT

In international logistics that accompany information flows, errors or inconsistencies of data tend to occur partly because of human interventions. To solve such problems, the present invention will be configured as follows:

The problems can be solved by a logistics control information system which comprises: a device (101) used for entering information, such as an item of cargoes to be exported, required for customs procedures; a device (105) used for creating electronic document data required for customs procedures based on the information required for customs procedures and transmitting it to a customs via a network; and a device (106) which receives the examination result of electronic document by the customs and transmit the received examination result to an information processing device of a party concerned which entered information required for customs procedures.

The present application claims priority from the Japanese patent application JP2003-093136 filed on Mar. 31, 2003, the content of which is hereby incorporated by reference into this application.

### BACKGROUND OF THE INVENTION

The present invention relates to control of complicated flows of information (information flows), and more specifically to control of flows of electronic documents (information) that are applied to customs of an importing country and are related to international logistics (trade) which accompanies complicated information flows.

With logistics in a country, some cases present versatile information flows because the logistics is subjected to restrictions by the country or goods to be transported. In general, however, information about the transportation of goods is allowed to flow between a shipper (consigner) and a receiver (consignee) via a communication network separately from vouchers attached to the goods and transportation of goods.

As for a trade, on the other hand, information flows arising as a result of logistics from a consigner to a consignee are versatile. A method for dealing with such versatile information flows is stated in Japanese Patent Laid-open No. 2001-243366. This patent document discloses a system that supports calculation of extra expenses to be added in a trade and preparation of necessary documents so that an orderer and an order receiver can execute procedures for accepting and ordering with foreign entities in similar ways to those for domestic transactions.

It should be noted that countries referred to in the present specification include what we call areas other than independent nations. More specifically, the term “countries” include such areas that have their own legislations or rules, for example, Hong Kong, Taiwan, and States of the United States of America.

### SUMMARY OF THE INVENTION

Under the circumstances of versatile information flows, human intervention will be likely to be present. When such intervention occurs, it is impossible to perfectly prevent occurrence of wrong data entry when certain information is re-entered. Further, an error is also likely to be caused when information is given and received via a network in the form of electronic data called electronic voucher or electronic documents, and such error cannot always be corrected in the network. One of such causes is a code conversion error resulting from a difference between codes that are used to electronically describe a language. Although the prior art described above discloses issues related to a trade, it does not takes in to consideration the environment surrounding information flows arising as a result of logistics. Moreover, the prior art does not disclose or suggest. any methods for eliminating occurrence of information errors and subsequent inconsistencies between information.

In view of the foregoing, it is an object of the present invention to provide a logistics control information system in which information errors and inconsistency between information are less likely to occur.

It is another object of the present invention is to provide a logistics control information system and method capable of reducing the effects of information errors and inconsistency between information on the surroundings.

Other objects of the present invention will be apparent from the disclosure of the present specification and the drawings attached thereto.

The objects of the present invention can be achieved by the following aspects:

According to an aspect of the present invention, there is provided a logistics control information system and method. The system includes: a device used for entering information including a name and quantity of the cargoes to be exported that are required for customs procedures; a device used for creating electronic document data required for customs procedures based on the information required for customs procedures and transmit the data to a customs via a network; a device which receives inspection results of the electronic documents by the customs; and a device which transmits the received inspection results to an information processing device of a party concerned which entered information required for customs procedures.

According to another aspect of the present invention, there is provided a logistics control information system and method. The system includes: a device used for entering information on cargoes to be exported; a device used for entering electronic document data required for customs procedures of goods; means for checking consistency between the information on the cargoes entered and the electronic document data; and a device which transmits the electronic document data via a network to the customs when consistency is verified by the above-described verification means.

Such aspects stated above intend to verify correctness of information by checking mutual relations between various information that controls logistics. If an information error is detected, procedures are carried forward while the errors are notified to parties concerned. Therefore, these aspects are effective when there are versatile information flows. In particular, they exert significant effects when information flows are complicated due to intricate procedures as seen in international logistics.

It is obvious that the objects of the present invention can also be achieved by other preferred embodiments that are disclosed in the section “Description of the Preferred Embodiments” of the Present Invention.

### BRIEF DESCRIPTION OF THE DRAWINGS

FIG. 1 is a diagram for explaining a flow of trade procedures according to a preferred embodiment;

FIG. 2 is a diagram for explaining procedures to notify customs declaration result in trade procedures;

FIG. 3 is a configuration diagram focusing on an information system to carry forward trade procedures according to the preferred embodiment;

FIG. 4 is a configuration diagram focusing on another information system to carry forward trade procedures according to the preferred embodiment;

FIG. 5 is a configuration diagram of S/I (Shipping Instruction) data;

FIG. 6 is a configuration diagram of I/V (Invoice) data;

FIG. 7 is a configuration diagram of P/L (Packing List) data;

FIG. 8 is a configuration diagram of B/L (Bill of Lading) data;

FIG. 9 is a configuration diagram of M/F (Manifest) data;

FIG. 10 is a configuration diagram of member data;

FIG. 11 is a flow chart of data entry/browsing processing;

FIG. 12 is a configuration diagram of declaration result data;

FIG. 13 is a flow chart of a series of processing including data transmission, creation of M/F data, and transmission of M/F;

FIG. 14 is a configuration diagram of consistency collation rules;

FIG. 15 is a configuration diagram of data on result-notifying parties;

FIG. 16 is a process flow chart of transmission result reception/declaration result notification; and

FIG. 17 is a diagram for explaining transition state of a display device window.

### DESCRIPTION OF THE PREFERRED EMBODIMENTS

The present invention is applicable to a case where versatile information flows are required as a result of logistics operations. Hereinafter, an information flow related to customs procedures (customs clearance) which is likely to give significant impacts to logistics operations by exemplifying a trade (international logistics operations) in which the advantages of the present invention noticeably appear will be described.

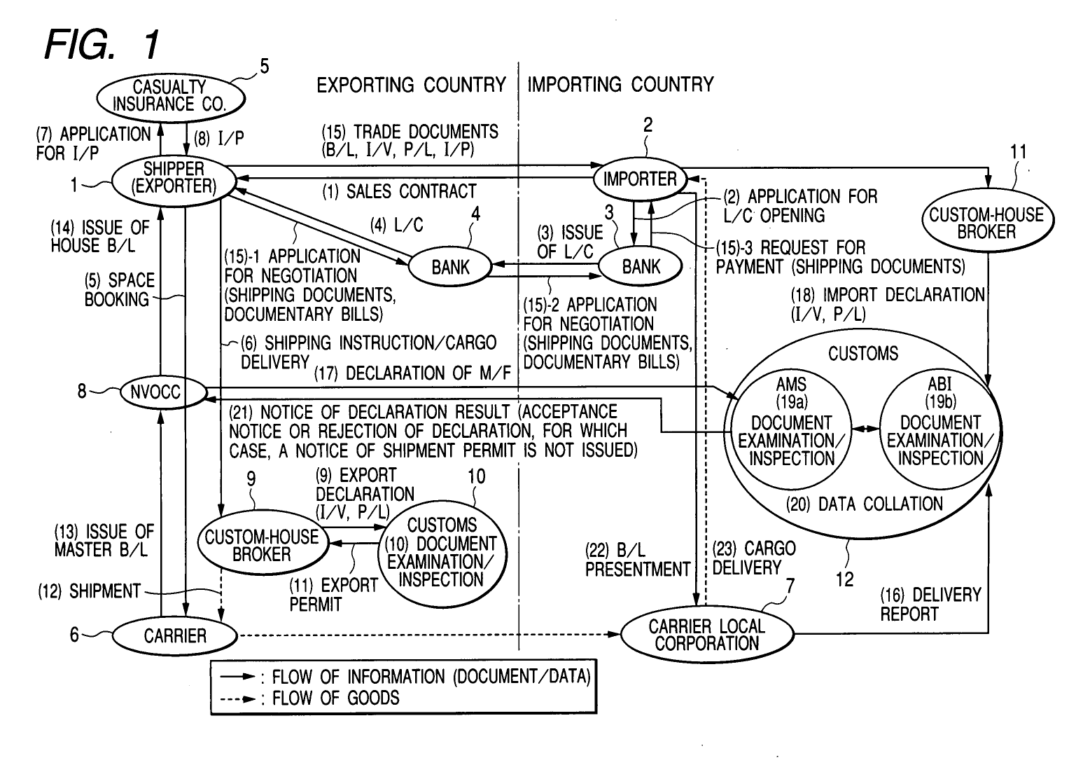

FIG. 1 illustrates the outline of various procedures related to a trade according to an embodiment of the present invention. An example of procedures for a case where a shipper (exporter) 1 in an exporting country exports cargoes to an importer 2 in an importing country is shown below. It should be noted that the shipper and the exporter are parties different from each other in many cases, but the two parties will not be distinguished since they can be treated as one entity for trade procedures. The procedures shown below are numbered as shown in FIG. 1. However, the order of procedures may not always be executed as numbered. When a relationship is maintained to prohibit advance to the next procedure unless the result of the prior procedures is reflected, the procedures may be arranged in a way that the numbers are in reverse order, or, otherwise, the procedures may be advanced concurrently.

(1) A sales contract is concluded between an exporter 1 and an importer 2.

(2) Based on the contract, the importer 2 applies a bank 3 in an importing country for opening a letter of credit (L/C)

(3) and (4) The L/C is dispatched to the exporter 1 via a bank 4 in an exporting country.

(5) The exporter 1 makes space booking to a custom-house broker 9 upon obtaining the L/C.

(6) Upon finalizing the space booking, the exporter 1 gives shipping instructions and dispatches cargoes to the custom-house broker 9.

(7) and (8) The exporter 1 applies a casualty insurance company for an insurance policy (I/P) for the cargoes and receives the I/P.

(9) The custom-house broker 9 makes an export declaration to customs 10 in the exporting country by attaching an invoice (I/V) and a packing list (P/L) which is a supplementary document to the invoice.

(10) and (11) The customs 10 executes examination/inspection of customs clearance documents and gives an export permit to the custom-house broker 9 if no problem is found.

(12) The custom-house broker 9, upon obtaining the export permit, instructs a carrier 6 to ship the cargoes.

(13) The carrier 6 issues a bill of lading (B/L) in favor of a non-vessel operating common carrier (NVOCC) 8. A B/L is a security that is issued by an NVOCC (the carrier 6 in general) in favor of the exporter 1 to certify shipment of cargoes. A B/L has characters of a receipt of cargoes, a proof of transport contract and a delivery bill. The B/L issued by the carrier 6 is called “Master B/L.”

(14) The NVOCC 8, upon receiving the Master B/L from the carrier 6, issues a House B/L in favor of the exporter 1. The Master B/L and the House B/L are each a B/L, although the entities to issue the B/Ls are different from each other.

(15) The exporter 1 applies the bank 4 for negotiation by dispatching shipping documents and documentary drafts including a B/L, an I/V and a P/L. The bank 4 applies the bank 3 for negotiation. The bank 3 dispatches the shipping documents to the exporter 2 and applies for payment. Descriptions of I/V and P/L are omitted here, but such documents are dispatched by the custom-house broker 9 together with a notification of export permit issued by the broker 9.

(16) When the cargoes arrive at a carrier local corporation 7, etc. of the carrier 6 in the exporting country from the carrier 6, the carrier local corporation 7 notifies a delivery report to the customs 12.

(17) On the other hand, the NVOCC 8 dispatches a manifest (M/F) to the customs 12 in the importing country. The M/F is a cargo manifest on which a Description of Goods, a consignee (exporter 2) , etc. are stated in the order of the port of loading, port of discharge, and B/L numbers of the loaded cargoes. Usually, the customs 12 in the importing country requests the NVOCC 8 to submit the M/F carrying the signature of the captain when the ship sails into the port and uses the MIF for controlling the cargoes or imposing a duty on the cargoes. Some countries also permit the NVOCC 8 to submit the M/F in addition to the carrier 6 to which the captain belongs.

(18) The custom-house broker 11 makes an import declaration to the customs 12 by attaching the I/V and the P/L dispatched by the importer 12.

(19) The customs 12 executes examination/inspection of customs clearance documents and gives an export permit to the custom-house broker 11 if no problem is found.

(20) and (21) The customs 12 collates the contents of M/F dispatched by the NVOCC 8 with the contents of I/V and P/L from the custom-house broker 11 and issues a notice of declaration result.

(22) and (23) When custom clearance is permitted, the carrier local corporation 7 dispatches the cargoes upon the presentation of the B/L by the importer 2.

In the above-stated procedures, descriptions in terms of processing by means of information systems are omitted here for simplification. Actually, such procedures are executed, by using information processing systems such as servers and personal computers, for areas to be covered by the exporter 1 and the importer 2 up to the customs 10 and 12, etc. Further, issuance, declaration, notification, etc. of various documents are executed via a network. The procedures are well defined by the disclosure of the patent document described above.

Under the circumstances of versatile information flows shown in FIG. 1, human intervention will be likely to be present. For example, certain information may be delivered via a facsimile machine in case of a poor condition of a network, etc. When such intervention is made, it is impossible to perfectly prevent occurrence of wrong data entry when certain information is re-entered. Further, an error is also likely to occur when information is given and received via a network in the form of electronic data called electronic voucher or electronic documents, and such error cannot always be corrected in the network. One cause of such error is a code conversion error resulting from a difference between codes that are used to electronically describe a language.

The present invention considers it to be a new problem to eliminate occurrence of information errors and subsequent inconsistency between information in a logistics environment that accompanies various information flows wherein such human intervention could occur.

An inconsistency between information is detected, for example, by collating contents of the manifest delivered by the NVOCC 8 at the customs 12 in the importing country with contents of the I/V or the P/L delivered by the custom-house broker 11. Such collation is performed for the purpose of controlling the cargoes or imposing a duty on the cargoes.

On the other hand, any inconsistency encountered as a result of the collation will result in delayed landing of the cargoes, thus causing serious problems for the exporter 1, the importer 2, etc. In particular, the problem will be more serious when the importing country is the U.S.A.

In the customs 12 in the U.S.A., a system to receive a customs declaration from the custom-house broker 11 is different from a system to receive an M/F form the carrier 6 or the NVOCC 8. The former system is called “Automated Broker Interface (ABI)”, which is connected to a computer of the custom-house broker 11 via a network. The latter system is called “Automated Manifest System (AMS)”, which is connected to a computer of the carrier 6 via a network. In December 2002 and thereafter, it has been permitted that a computer of the NVOCC 8 is connected to the AMS via a network, as shown in FIG. 1.

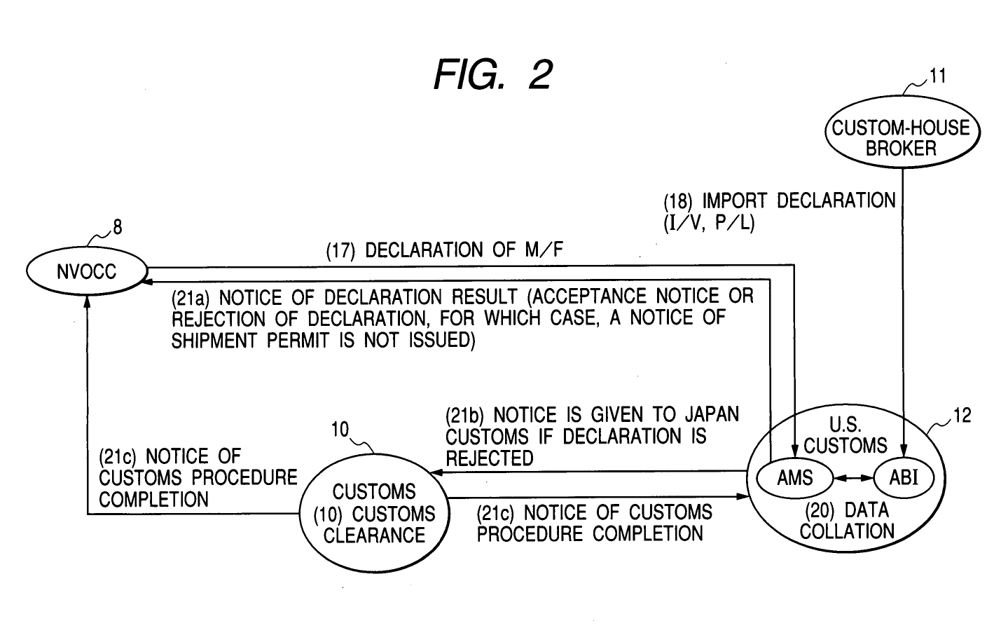

FIG. 2 shows detailed procedures related to the customs 12, assuming the importing country is the U.S.A. Descriptions of the items that have been already explained for FIG. 1 will be omitted here. The customs 12 checks contents of M/F delivered to the AMS by the NVOCC 8, collates the contents with those of the I/V or the P/L delivered to the ABI by the custom-house broker 11, and issues a notice of declaration result 21a. If any problem is found in the contents of the M/F and the collation result, the customs 12 dispatches a rejection notice of the declaration to the NVOCC 8. The customs 10 in the exporting country, upon completing customs clearance (examination of customs clearance documents and inspection of cargoes), dispatches a notice of customs procedure completion to the NVOCC 8 via a U.S. Customs 12 and the custom-house broker 9. In FIG. 1, procedures subsequent to the completion of customs clearance have been briefly described. The rejection notice of declaration implies that a notice of shipment permit is not issued since the regulations were revised that, in December 2002 and thereafter, a declaration of M/L must be completed 24 hours before cargoes are laden aboard the vessel. As stated in the above, it is a serious problem for the exporter 1 or the importer 2 that time required for logistics becomes longer even when loading is delayed under existing circumstances. When the notice of shipment permit is not issued, it is obvious under the new circumstances that the situation will be more serious.

The description is made in the above by way of example of the U.S. Customs, but other countries are taking the similar measures to revise their regulations, and similar problems will be anticipated to occur.

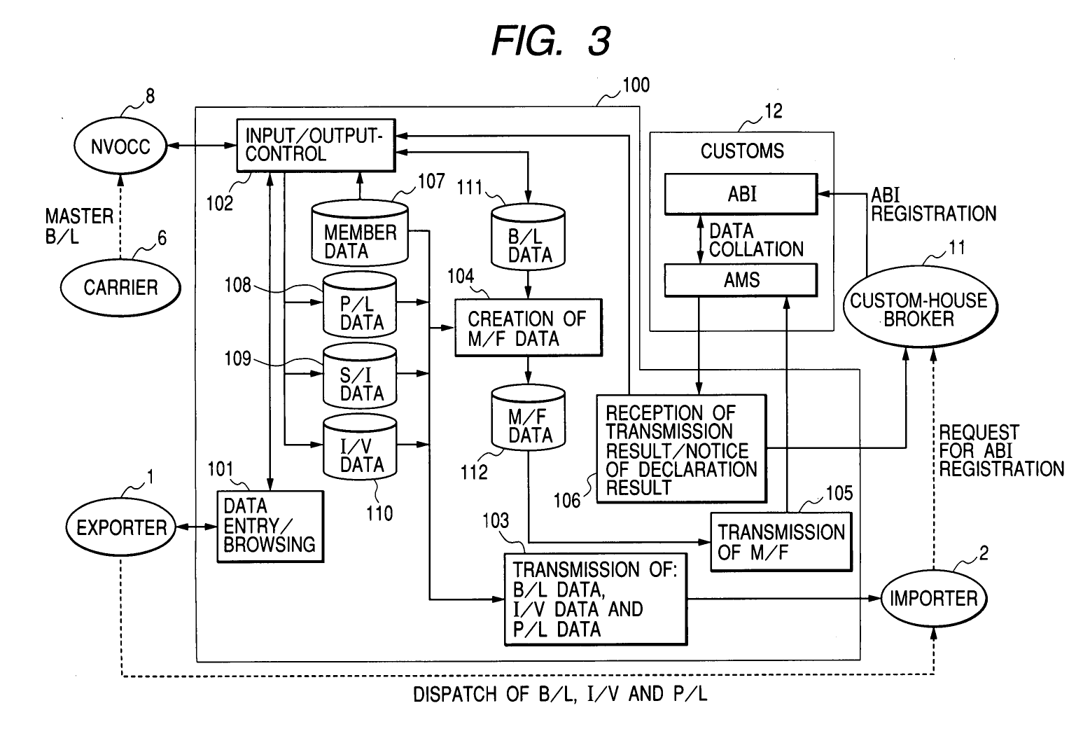

Hereinafter, a system configuration to execute a declaration of the M/L and subsequent procedures shown in FIG. 1 will be described with reference to FIG. 3. An information system 100 will be provided to execute such procedures. As it is clear from FIG. 3, the information system 100 is connected to the exporter 1, the importer 2, the NVOCC 8, the custom-house broker 11, the customs 12, etc. via a network. The information system 100 may be an independent system that is connected to the exporter 1, the customs 12, etc. Alternatively, however, as it is clear from FIG. 3, the system 100 may be configured as an information system that is owned by the NVOCC 8 or others. Further, since the carrier 6 is accessible to the customs 12 in the exporting country in the similar way as the NVOCC 8, the information system 100 may be realized as an information system of the carrier 6.

The information system 100 incorporates modules including data entry/browsing 101 which provides a user interface to the exporter 1 via a network; input/output-control 102 which controls an interface with the NVOCC 8 and the entire information system; transmission of B/L data, I/V data and P/L data, etc. 103 to the importer 2 from the system 100 (hereinafter, the transmission may sometimes be called simply as “data transmission”); creation of M/F data 104 based on the B/L data, etc.; transmission of M/F 105 which transmits the M/F data created to the customs 12 in the importing country; and reception of transmission result/notice of declaration result 106 which receives the transmission result of the M/F or the declaration result to the customs 12 from the customs 12 via a network. In FIG. 3, data flows are shown with arrows to make operations of the information system 100 more understandable. However, it can be easily understood that the data flows are not limited to directions indicated by arrows, and there are other data flows that are not indicated by arrows.

To execute various procedures, the information system 100 has a database that accommodates data including: member data 107; P/L data 108; S/I data 109; I/V data 110; B/L data 111; and M/F data 112.

From the viewpoint of an information system owned by parties involved in a trade, since the configuration of the information system 100 shown in FIG. 3 is provided with various database related to trades and the configuration functions as a portal site that intensively processes and provide data of such databases, information errors or inconsistencies between information will be less likely to occur, and if any of such problems occurs, impacts on logistics can be minimized.

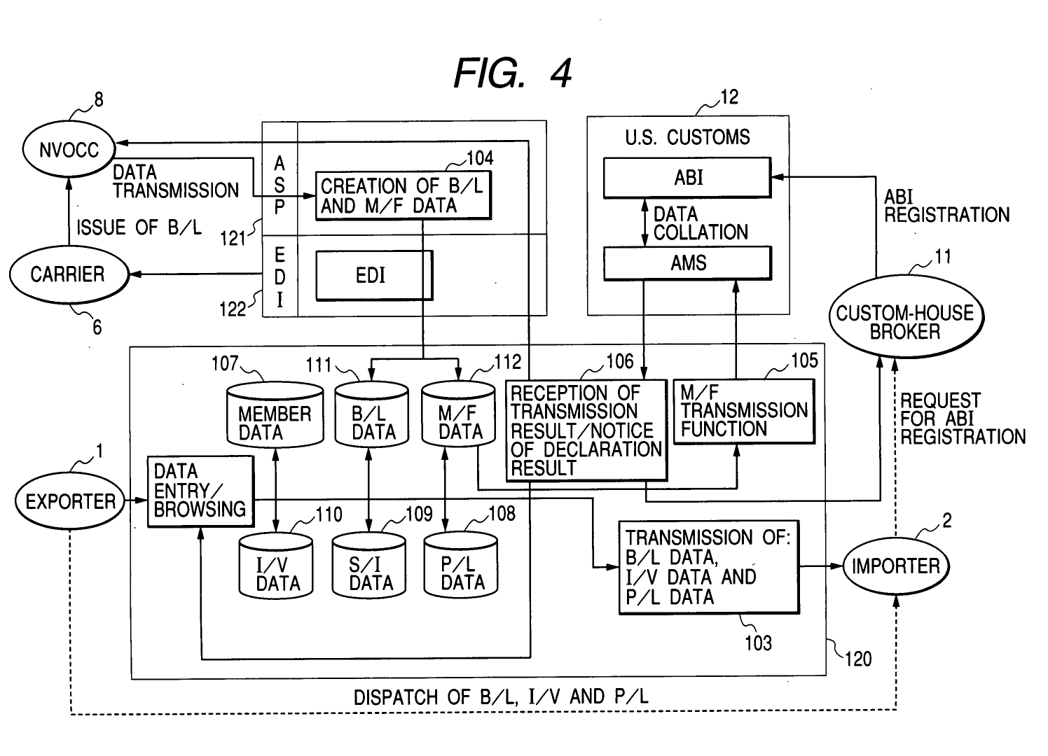

FIG. 4 shows a preferred embodiment differently configured as that of FIG. 3. Under existing circumstances, an Application Service Provider (ASP) which creates the B/L data or the M/F data exists, and various Electronic Data Interchange (EDI) services as shown in the Japanese Patent Laid-open No. 2001-243366. The embodiment of FIG. 4 shows a system configuration that is arranged to deal with such existing circumstances. In addition, its core is the information system 120. Accordingly, the information system 120 may be arranged in a service site of the ASP or the EDI, or otherwise, the system may be configured as part of an information system of the NVOCC 8, etc., as is the case with the embodiment of FIG. 3.

The information system 120 shown in FIG. 4 differs from the information system 100 shown in FIG. 3 in the point that the B/L data and the M/F data are created by the ASP based on data delivered from the NVOCC 8. The data that is used to create the B/L data and the M/F data in the service sites of the ASP and the EDI may be obtained by accessing databases of the information system 100, or through the data transmission by the NVOCC 8 which separately obtained the data from the exporter 1. In FIG. 4, the input/output-control 102 in the information system 120 shown in FIG. 3 is omitted. However, it is clear that the information system 120 has a module which has an self-controlling interface to receive data from the service sites of the ASP and the EDI.

The information system 120 in FIG. 4 no only has the smaller number of functions than that of the information system 100 in FIG. 3, but simplifies its system configuration by sharing functions with the service sites of the ASP and the EDI.

Hereinafter, databases and respective procedures of the information systems 100 and 120 shown in FIGS. 3 and 4 respectively will be described in detail. It should be noted that descriptions of the databases will be made by illustrating an entry (a data record associating with an issue) to make the drawing brief and to the point. However, it should be self-explanatory that many entries exist.

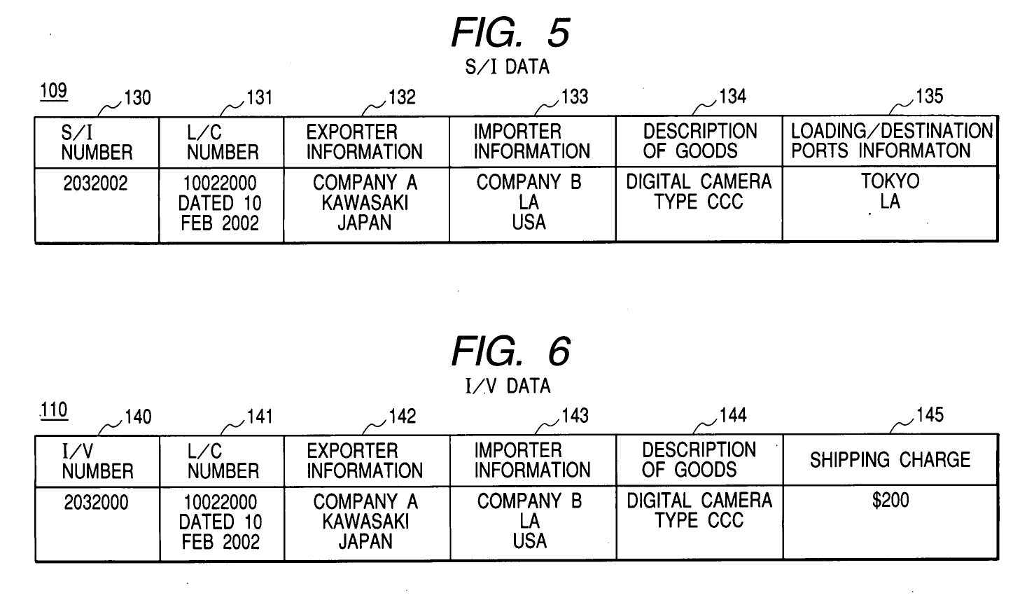

FIG. 5 shows a configuration of the S/I data 109. The S/I data includes: an S/I number 130 for identifying the S/I; an L/C number 131 for identifying the L/C associated with the S/I (which may include the issuance date of the L/C as shown in FIG. 5) ; exporter (consigner) information 132 on, e.g., a company name and an address of the company; importer information 133; description of goods 134 including name/type, quantity and weight of cargoes; and loading/destination ports information 135 including the port of loading and the destination port. For the loading/destination ports information 135, the term “port” should be substituted with “port” for vessels, while “airport” for airplanes.

FIG. 6 shows a configuration of the I/V data 110. The I/V data include: an I/V number 140 for identifying the I/V; an L/C number 141 for identifying an L/C associated with an invoice; exporter information 142; importer information 143, a description of goods 144 including name/type, quantity and weight of cargoes; and shipping charge 145.

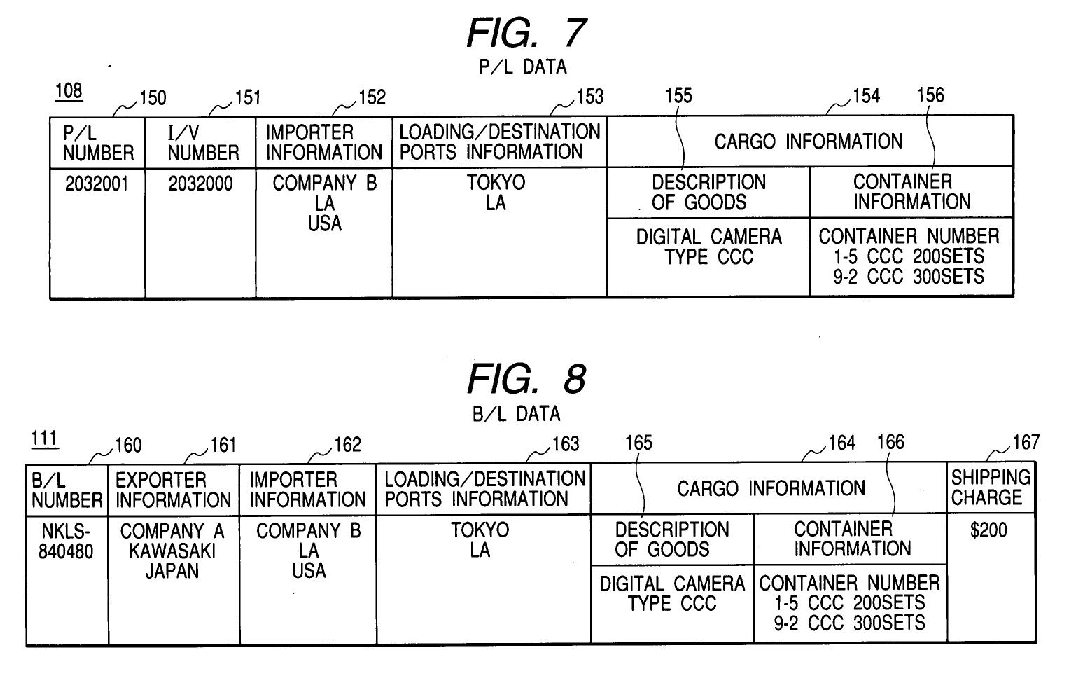

FIG. 7 shows a configuration of the P/L data 108. The P/L data include: a P/L number 150 to identify a packing list; an I/V number 151 to identify an invoice associated with a packing list; importer information 152; loading/destination ports information 153; and cargo information 154. The cargo information 154 includes description of goods 155 and container information 156. The container information 156 includes a container number, the name and quantity of cargoes to be loaded in a container.

FIG. 8 shows a configuration of the B/L data 111. The B/L data 111 includes: a B/L number 160 to identify a bill of loading; exporter information 161; importer information 162; loading/destination ports information 163; cargo information 164; and shipping charge 167. The cargo information 164 includes the description of goods 165 and container information 166.

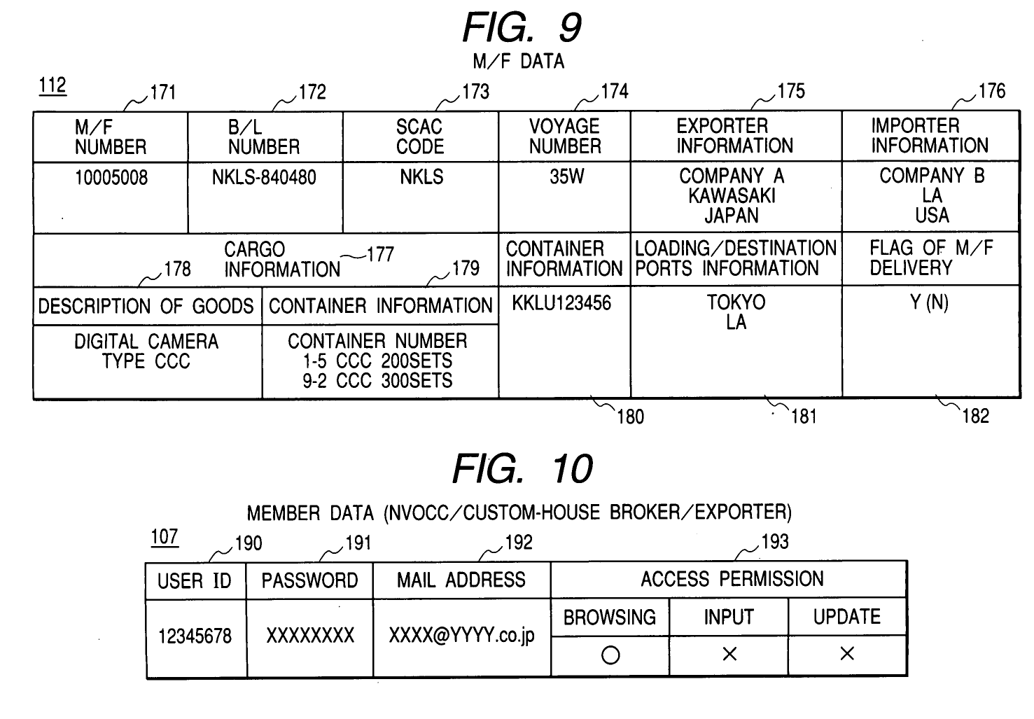

FIG. 9 shows a configuration of the M/F data 112. The M/F data includes: an M/F number 171 to identify a manifest; a B/L number 172 to identify a bill of loading associated with the manifest; a carrier SCAC code 173 that is pre-assigned to the carrier 6 (an SCAC cord is a four-letter code in English prefixed to the B/L number); a voyage number 174 (a flight number for air cargo); exporter information 175; importer information 176; cargo information 177; container information 180; loading/destination ports information 181; and a flag of M/F delivery 182 which indicates whether or not the manifest has been delivered to the customs 12. The cargo information 177 includes description of goods 178 and container information 179 in which the cargoes are loaded.

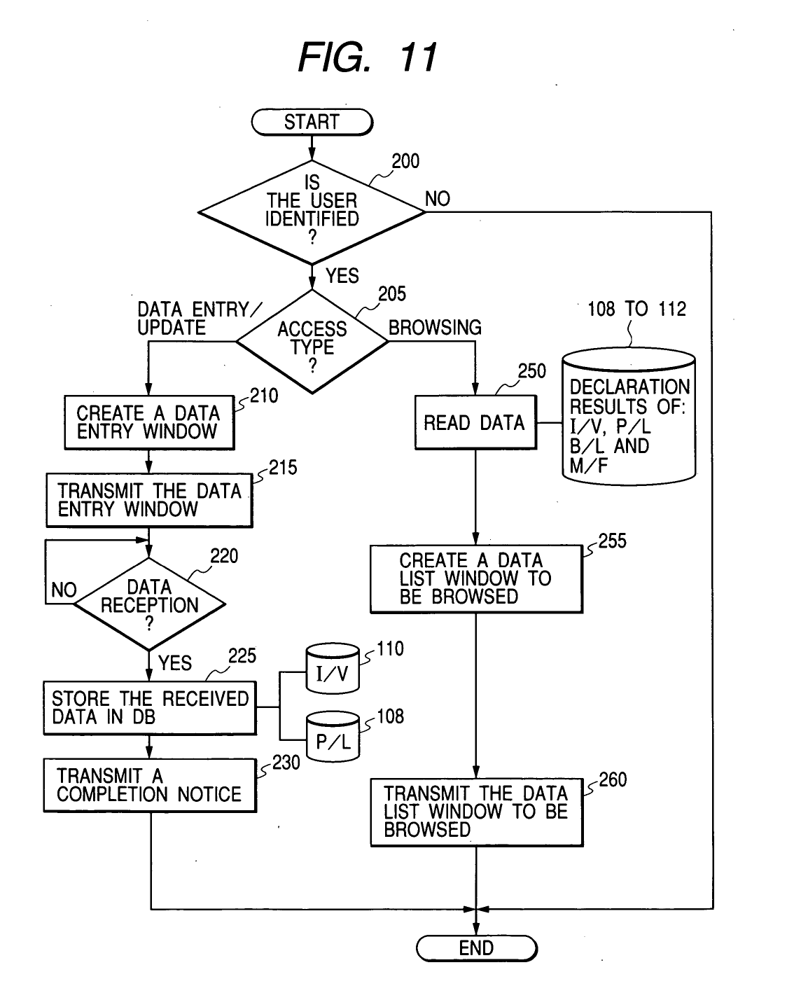

FIG. 10 shows a configuration of the member data 107. A description of the member data 117 will be made by way of example wherein the information systems 100 and 120 are provided independent of existing information systems of parties concerned. In FIGS. 2 and 3, it was illustrated that only the exporter 1 and the NVOCC 8 access the information systems 100 and 120 respectively. However, since the custom-house brokers 9 and 11, the importer 2, etc. are also the members, the member data 117 includes: a user ID 190 to identify such entities, a password 191 to be used when each member is accessing the information system 100 or 120 via a network, a mail address 192 as a contact address, and an access permission 193. The access permission 193 shows, when access is made to the information system 100 or 120, whether or not the access is permitted. In FIGS. 3 and 4, the access permissions to the information system 100 or 120 include types of “browsing”, “input”, “update”.

FIG. 11 shows a flow chart describing procedures of the data entry/browsing module 101. The module 101 makes a judgment as to whether or not an accessing user is a member by making a judgment as to whether or not the user ID 190 of the member data 107 and the password 191 match (Step 200). If the user is found to be a non-member, the procedures will be terminated and reject the user access. If the user is a member, then, an access type is judged and a judgment is made as to whether the user has the access permission (Step 205). If the user ID 190 shown in FIG. 10 is “12345678”, then, the browsing of the information systems 100 and 120 is permitted, and the procedures will be terminated without permitting data input or data update (not shown).

If the access permission is limited to “data entry” or “update”, the information systems 100 and 120 prepare a window data to enable entry or update of member data (Step 210), and transmit the window data to an information system (e.g., a personal computer) of the member making access thereto via a network (Step 215). After entry or update of data by the member is waited for (Step 220) , if the data is received, the systems 100 and 120 store the received data on databases including the I/V data 110 and the P/L data that are appropriate for the received data. Upon completing the storage of the received data to the specified database, the module transmits a completion notice to the information system of the member (Step 230), and terminates the procedures.

If the access permission is “browsing”, data to which a read-only access is requested is read from databases including the P/L data 108, the S/I data 109, the I/V data 110, the B/L data 111, the M/F data 112, and declaration result data 270 (Step 250), a requested data list window to be browsed is created (Step 255), the window data is transmitted to the information system of the accessing member (Step 260), and the procedures are terminated.

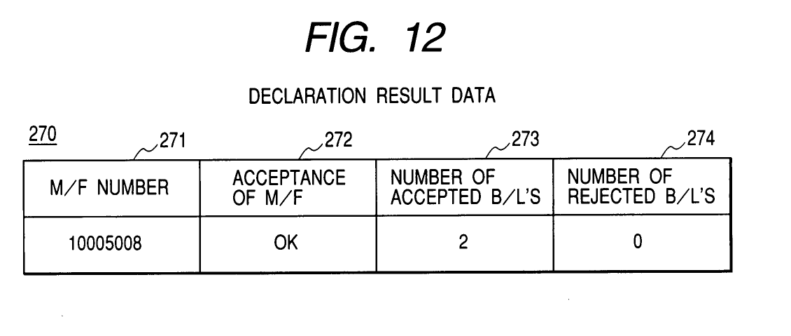

Hereinafter, the declaration result data 270 will be described with reference to FIG. 12. Although not illustrated in FIGS. 3 and 4, the declaration result data 270 is a response data delivered by the customs 12 to the M/F data 112 delivered to the customs 12. Accordingly, the declaration result data 270 includes an M/F number 271, acceptance of M/F (including the reception condition) 272 by the customs 12 in association with the M/F number 271, the number of accepted B/Ls 273 by the customs 12, and the number of rejected B/Ls 274 by the customs 12.

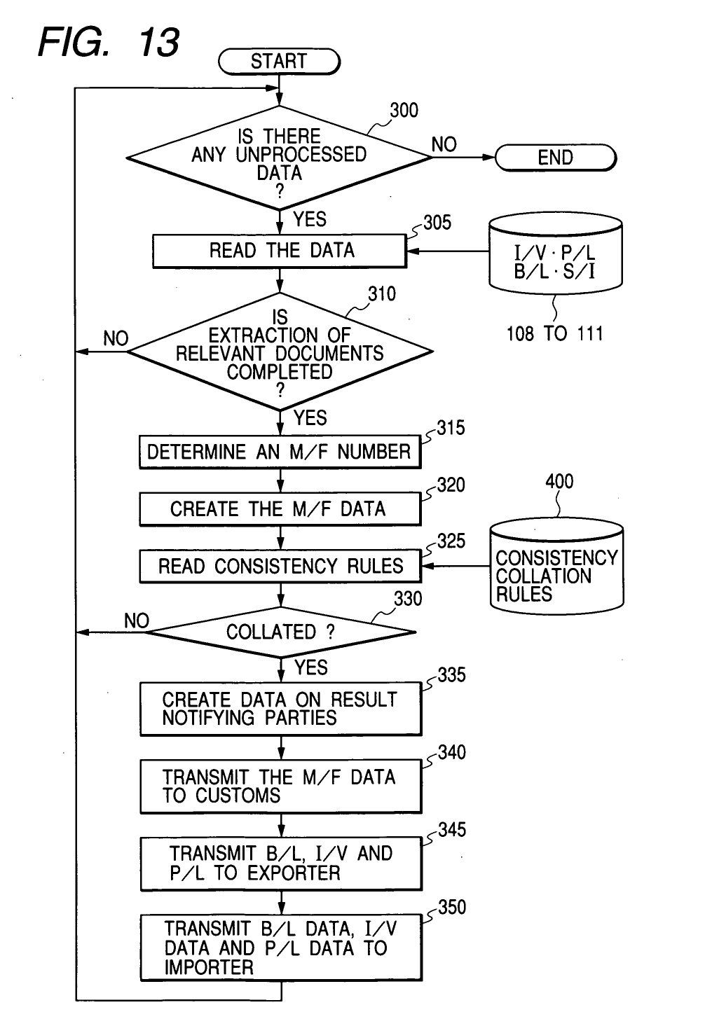

Hereinafter, a series of processes performed by modules including the transmission of data 103, the creation of M/F data 104 and the transmission of M/F will be described with reference to FIG. 13. A judgment is made whether or not data that should be delivered to the customs 12 exists (Step 300). If no data exists, then, the process is terminated. If any unprocessed data exist, the P/L data 108, the S/I data 109, the I/V data 110, the B/L data 111, etc. are read (Step 305) and necessary document data relating to an issue to be processed are extracted (Step 310). Necessary document data is extracted using a code to identify the issue if the code is attached to document data including the P/L data 108 and the S/I data 109. However, if any identifying code is not attached, necessary document data relating to the issue to be processed are extracted by checking the relationship of contents of the document data as stated below. I/V. I/V number=P/L. I/V number and B/L.importer information=I/V.importer information and B/L.exporter information=I/V.exporter information and B/L.product information=I/V.importer information. Here, the I/V.I/V number implies the I/V number 140 of the I/V data 110.

If the necessary document data cannot be extracted, this means data necessary for advancing processes such as creation of M/F data are incomplete, and the process is resumed at step 300. Although illustration is omitted in FIG. 13, there may be a case that existence of an error in data is sometimes judged to be incomplete data, in addition to the case that necessary data is simply incomplete. Therefore, it is preferable to arrange the process to indicate such situation on an operator terminal unit of the information systems 100 and 120, and resume the process at Step 300 after adequate processes is achieved by the operator.

When the necessary document data are extracted, an M/F number is determined based on the specified rules (Step 315), and the M/F data 112 is created (Step 320). The SCAC code 173 of the M/F data 112 corresponds to four alphabetical letters prefixed to the B/L number 160 of the B/L data 111. Data of the M/F data 112 except the SCAC code 173 are duplicated copies of the P/L data 108, the S/I data 109, the I/V data 110, the B/L data 111, etc.

After the M/F data112 is created, consistency collation rules 400 are read to verify the correctness of the data created (Step 325). In addition, relationships between the M/F data 112, the P/L data 180, the S/I data 109, the I/V data 110, the B/L data 111, etc. are collated pursuant to the rules (Step 330). Much of the M/F data 112 are duplicated copies of the P/L data 180, the S/I data 109, etc., but inconsistencies will occur in the following cases. For example, data corresponding to the exporter information 175 of the M/F data 112 are the exporter information 132 of the S/I data 190, the exporter information 142 of the I/V data 110 and the exporter information 161 of the B/L data 111. The information systems 100 and 120 create the exporter information 175 of the M/F data 112 by copying either one corresponding data. Accordingly, if data of the copying source are different from other data, mutual inconsistencies should exist. Such inconsistencies occur when data entries are made by the exporter 1 or the NVOCC 8, if the exporter 1 or the NVOCC 8 is trying to enter the exporter information 132 of the S/I data 109, the exporter information 142 of the I/V data 110 and the exporter information 161 of the B/L data 111 independently according to such document data. Such problem occurs because the information systems 100 and 120 are built under the concept to give a sense of security to a data entry operator by creating data according to documents. On the other hand, for example, if the information systems 100 and 120 are built under the concept wherein, when exporter information is entered once, the data is stored as the exporter information 142 of the I/V data 110 and the exporter information 161 of the B/L data 111, data entry operationality will be improved and inconsistencies between data will be less likely to occur, but the sense of security will be deteriorated instead. Of course, either concept may be employed, but, with the present invention, the concept for dealing with inconsistencies between data, even if such inconsistencies occur, is employed.

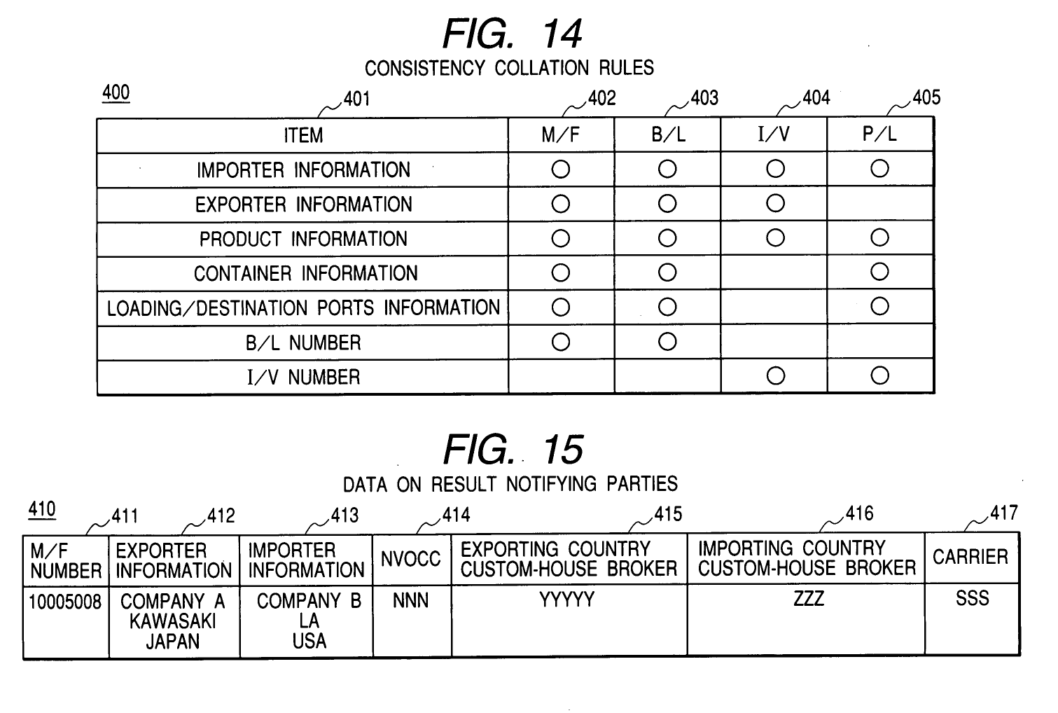

The consistency collation rules 400 as shown in FIG. 14 are used to check consistency (Step 330). The consistency collation rules 400 is a table to cross-reference information 401 to be checked with M/F data 402, B/L data 403, etc. that exist in the information 401, and consistency between data is verified according to the existence of data by referring to the table 400.

As a result of a consistency check (Step 330) , if any inconsistency is found, the process is resumed at Step 300. Although an illustration is omitted in FIG. 14, since the data is judged to be wrong, it is preferable to arrange the process to indicate such situation on an operator terminal unit of the information systems 100 or 120, and resume the process at Step 300 after adequate processes is achieved by the operator.

When the correctness of data is verified, data on result notifying parties 410, by which the data delivery result of the M/F data 112 to the customs 12 is notified, is created. FIG. 15 shows the data on result notifying parties. Since declaration result is notified by the customs 12 according to the M/F numbers, the data on result notifying parties 410 should include an M/F number 411 which should act as a key for retrieving notifying parties of the result, exporter information 412, importer information 413, information 414 on the NVOCC 8, exporting country custom-house broker 415, importing country custom-house broker 416 and information 417 on the carrier 6. Each piece of such information includes contact addresses such as a mail address. Such information is entered to the information systems 100 and 120 by the exporter 1 or the NVOCC 8 at the time of entering other data, but details will be omitted here. As stated in the above, if the information systems 100 and 120 are built and operated as part of the systems of the NVOCC 8, for example, the information 414 on the NVOCC 8 may not be included in the notifying parties. Further, such data on notifying parties of parties concerned that is not required to be notified as intended by the exporter 1, etc. making entries of notifying parties are left blank.

Next, the M/F data 112 is transmitted to the customs 12 via a network, and the forwarding completion flag 182 of M/F date 182 is turned on (Step 340). Here, ON and OFF of the flag may be indicated by using numerals of 1 and 0, respectively. Alternatively, YES and NO of transmission may be indicated by using letters as illustrated. -The P/L data 108, the I/V data 110, the B/L data 111, etc. are transmitted to the exporter 1 (Step 345) ,subsequently, to the importer 2 (Step 350), a series of processes are terminated, and Step 300 is resumed. Transmission of data to the exporter 1 implies notification of a series of processes of the M/F data 112 covering the processes up to transmission to the customs 12, while transmission to the importer 2 is arranged so that the custom-house broker 11 in the importing country can advance customs clearance early at the customs 12 by the instruction of the custom-house broker 11. Actually, however, the P/L data 108, the I/V data 110 and the B/L data 111 may sometimes be transmitted to the custom-house broker 11 from the importer 2 via facsimile. In such a case, data will be re-entered to respective information systems by the importer 2 or the custom-house broker 11. Such re-entry of data tends to cause entry errors, resulting in a problem that custom clearance at the customs 12 cannot be achieved smoothly. To deal with such problems, with the embodiment, various electronic data are transmitted from the information systems 100 and 120 via a network also to the importer 2. It will be self-explanatory that various electronic data can be transmitted, as required, from the information systems 100 and 120 via a network to the custom-house broker 11 or the system of the customs 12 connecting to the custom-house broker 11.

When a transmission error, etc. occurs during the transmission of the M/F data 112 to the customs 12, the information systems 100 and 120 re-transmit the M/F data 112.

The customs 12 examines each items to cross-check contents of the M/F data 112 transmitted by the information systems 100 and 120 with contents of import declaration which accompanies the P/L data 108 and the I/V data 110 from the custom-house broker 11, and also examines if there is no discrepancy or inconsistency in the common items of the two contents. The examination result of declaration contents is transmitted to the information systems 100 and 120 via a network.

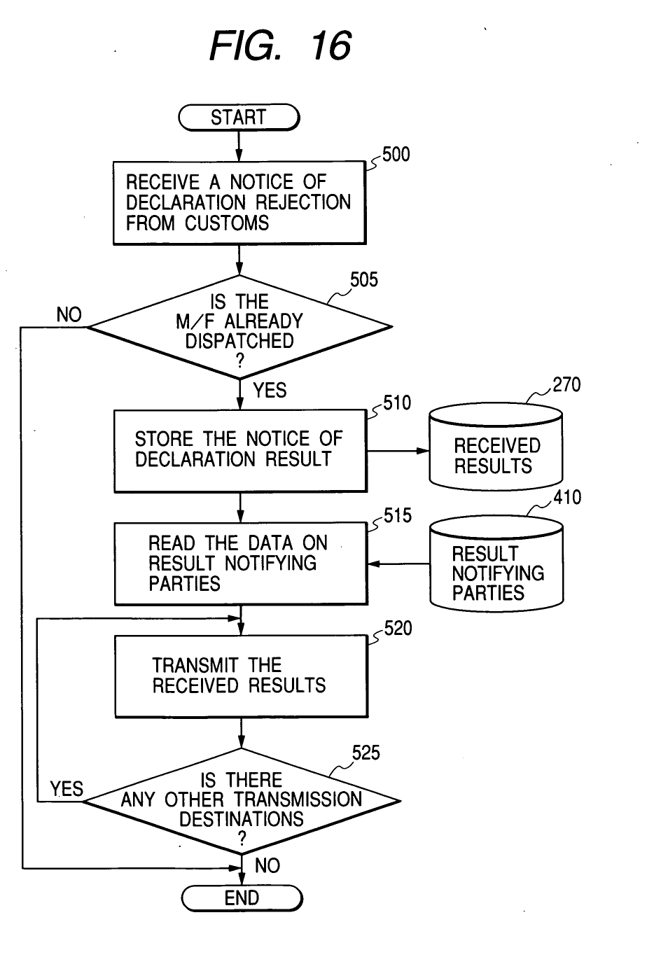

FIG. 16 shows processes of the reception of transmission result/notice of declaration result 106 that is arranged to be ready for receiving the examination result of the declaration contents. When a notice is received (Step 500) the forwarding completion flag of the M/F data 112 shown in FIG. 9 is checked by referring to the M/F number contained in the notice (Step 505). If the forwarding is not completed, the process is terminated since the contents received are wrong. In the case of wrong reception, it is preferable that the process should be terminated after a certain message is transmitted to the customs 12. The result received is stored as the declaration result data 270 (Step 510). Storing of the declaration result data 270 is executed to realize a browsing function to be provided to members by the information system 100 and 120 as described earlier.

Then, the data on result notifying parties 410 is read (Step 515), the declaration result data 270 is transmitted (Step 520) in sequence to notifying parties (Step 525), and the processes are terminated. Transmission of the declaration result data 270 may be either of a sequential transmission or a multi-cast.

As stated above, parties concerned are able to know the declaration result at an early point by transmitting the result of declaration data examination by the customs 12 to parties concerned with an issue. In particular, if a declaration is rejected and rejection of declaration contents occurs as a result of mutual inconsistency of data transmitted by a plurality of parties concerned to the customs 12, actions to deal with the situation-by respective parties concerned can be realized at an early point. As stated earlier, in trade procedures where a certain logistics accompanies a plurality of information flows and errors tend to occur as a result of wrong data transmission or manual data re-entry, an early notification of declaration result is mandatory, and the embodiment has achieved this. Although a description with reference to drawings will be omitted here, it is possible to verify locations of and contents of errors and make it feasible to correct wrong data by dispatching not only a notice of examination result, but also various data that come up with a declaration to parties concerned from the information systems 100 and 120.

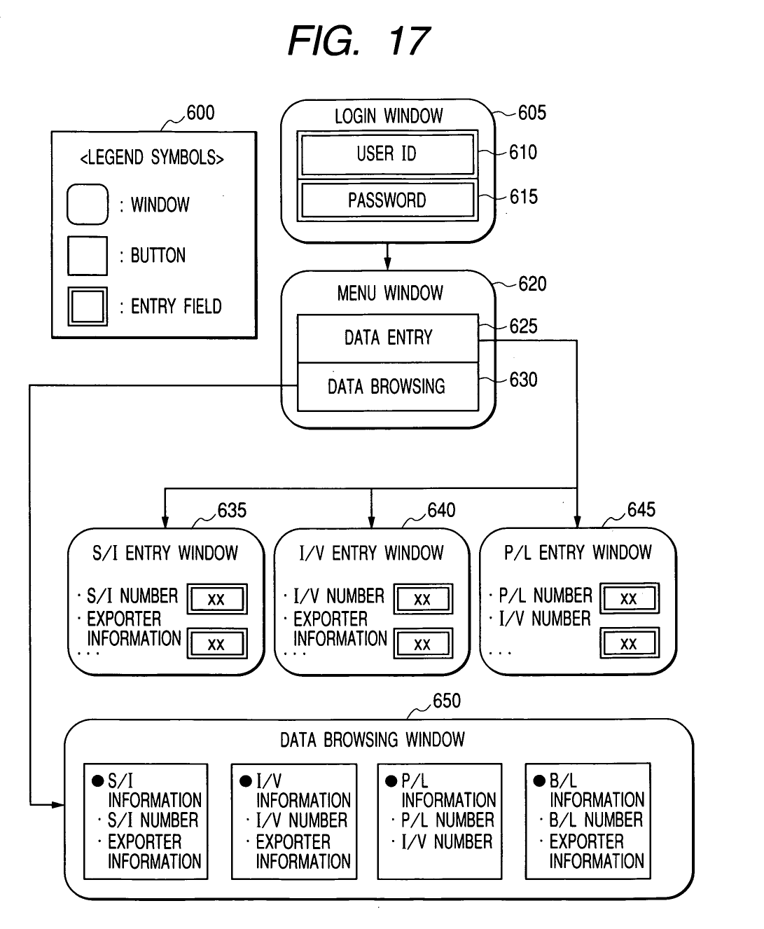

FIG. 17 shows a transition state of a display device screen at a party concerned (user) such as the exporter 1 that is connected to the information systems 100 and 120 via a network. As indicated by examples 600, the screen is configured to allow easy operations with a screen, a button which accepts user operations by using a pointing device such as a mouse, and an entry field used by a user to enter data.

A login window 605 is provided with data entry fields of a user ID 610 and a password 615. When a user enters such data, the data are used for user identification by the information systems 100 and 120, as stated earlier.

When the user identification is completed, a menu window 620 is displayed on the display device by the information systems 100 and 120. On the menu window 620, buttons are displayed so that a user can choose either a data entry 625 or a data browsing 630. Entry windows are displayed when the data entry 625 is chosen. Although an illustration is omitted here, an S/I entry window 635, an I/V entry window 640, a P/L entry window 645, etc. can be chosen according to the types of electronic document data. A description of subsequent specific data entry operations will be omitted here since such operations can be easily understood by those skilled in the art. It should be noted that, as stated earlier, items common to a plurality of electronic document data may be entered in a single operation, and the information system 100 and 120 may store the data entered in a plurality of locations as specified electronic document data.

When the data browsing 630 is chosen on the menu window 620, a data browsing window 650 is displayed. Although an arrangement is illustrated here to display data that a user want to browse according to the choice of item by the user, the point is to offer an arrangement that allows the user to see the desired data with simple operations and the display contents are easily viewable, and various display methods and window transition methods will occur to those skilled in the art.

As described in the above, according to the embodiment, it is possible to realize, in an environment of complicated information flows that occur as a result of international logistics, a logistics control system and method which can reduce data errors by checking interrelationships between data. Even if a data error occur, since the system and the method can notify occurrence of error, location of error, etc. to information systems of many parties concerned in international logistics within a short period of time, it is possible to reduce delays in shipment or delays in discharging.

According to the present invention, it is possible to reduce information errors or occurrence of inconsistencies between information, and if such problems occur, it is possible to reduce impacts on logistics.

What is claimed is:

1. A logistics control information system to process logistics control information for controlling logistics of cargoes, said system comprising:
a device used for entering information required for customs procedures including at least information related to cargoes to be exported;
a device used for creating electronic document data required for customs procedures based on said information required for customs procedures and transmitting said data to a customs via a network;
a device which receives a result of examination by said customs on said electronic document transmitted; and
a device which transmits said examination result received to an information processing device of a party concerned which entered at least said information required for customs procedures.

2. A logistics control information system according to claim 1, wherein said result of examination by said customs on said electronic document transmitted is a result that is obtained after consistency with different data on said cargoes from said electronic document transmitted is checked.

3. A logistics control information system according to claim 1, wherein said information processing device of a party concerned is an information system that is owned by at least one of an exporter, a custom-house broker, a nonvessel operating common carrier (NVOCC) and a carrier.

4. A logistics control information system according to claim 1, wherein said information on cargoes to be exported includes information to specify said cargoes, loading port information of said cargoes, and destination information of said cargoes.

5. A logistics control information system according to claim 1, wherein part of information on said cargoes to be exported is entered as at least two different types of data among packing list data, shipping instruction data, invoice data and bill of lading data as electronic document data.

6. A logistics control information system according to claim 5, wherein, if data entry of part of said information on cargoes to be exported is divided and executed a plurality of times to deal with said electronic document data, parts of said information that are entered said plurality of times are cross-referenced.

7. A logistics control information system according to claim 5, wherein said part of said information on cargoes to be exported is entered and stored as said at least two different types of data.

8. A logistics control information system to process logistics control information for controlling logistics of cargoes, said system comprising:
means for entering at least information on cargoes to be exported;
means for entering electronic documents data that is required for customs procedures of said cargoes;
means for checking consistency of information on said cargoes entered and said electronic document data entered; and
means for transmitting said electronic document data to a customs via a network when the consistency is verified by said checking means.

9. A logistics control information system to process logistics control information for controlling logistics of cargoes according to claim 8, said system including a device used for receiving an examination result of said electronic document data transmitted to said customs.

10. A logistics control information system to process logistics control information for controlling logistics of cargoes according to claim 9, said system including means for transmitting said examination result received to an information processing device that is connected to means for entering said electronic document data.

11. A logistics control information system according to claim 9, wherein said result of examination on said electronic document by said customs is a result that is obtained after consistency with different data of said cargoes from said transmitted electronic document is checked.

12. A logistics control information method for processing logistics control information for controlling logistics of cargoes by using a computer, said method comprising the steps of:
entering information required for customs procedures including at least information on cargoes to be exported;
creating electronic document data required for customs procedures based on said information required for customs procedures;
transmitting said created electronic document data to said customs via a network;
receiving a result of examination conducted by said customs on said transmitted electronic document; and
transmitting said received examination result to at least an information processing device of a party concerned which entered said information required for customs procedures.

13. A logistics control information method for processing logistics control information for controlling logistics of cargoes according to claim 12, wherein said result of examination on said electronic document by said customs is a result that is obtained after consistency with different data on said cargoes from said transmitted electronic document is checked.

14. A logistics control information method for processing logistics control information for controlling logistics of cargoes according to claim 12, wherein said information processing device of the party concerned is an information system that is owned by at least one of an exporter, a custom-house broker, a nonvessel operating common carrier (NVOCC) and a carrier.

15. A logistics control information method for processing logistics control information for controlling logistics of cargoes according to claim 12, wherein part of said information on cargoes to be exported is entered as at least two different types of data among packing list data, shipping instruction data, invoice data and bill of lading data as electronic document data.

16. A logistics control information method for processing logistics control information for controlling logistics of cargoes according to claim 15, wherein, if data entry of part of said information on cargoes to be exported is divided and executed a plurality of times to deal with said electronic document data, parts of said information that are entered said plurality of times are cross-referenced.

17. A logistics control information method for processing logistics control information for controlling logistics of cargoes according to claim 15, wherein part of said information on cargoes to be exported is further entered and are stored as said two different types of data.
